(19) United States
(12) Patent Application Publication
(10) Pub. No.: US 2010/0187821 A1
(43) Pub. Date: Jul. 29, 2010

(54) SUSTAINABLE PROCESS OF CLEAN ENERGY GENERATION AND DISTRIBUTION

(76) Inventor: Edson De Souza, Campinas (BR)

Correspondence Address: KF ROSS PC, 5683 RIVERDALE AVENUE, SUITE 203 BOX 900, BRONX, NY, 10471-0900, US

(21) Appl. No.: 12/389,014

(22) Filed: Feb. 19, 2009

(30) Foreign Application Priority Data
Apr. 9, 2008 (BR) PI0801284-9

(51) Int. Cl. H02K 7/18; H02K 53/00

(52) U.S. Cl. 290/50; 415/916

(57) ABSTRACT

Sustainable process of clean energy generation and distribution, belonging to the field of energy production, comprising a generator system that contains engine, reductor, tension transformer, current rectificator, also named electric-electronic switched power supply, and battery banks, which waive re-feeding, either by means of gas, alcohol, gasoline, diesel, and coal, wind, nuclear, thermoelectric, hydroelectric or any other, since the energy is supplied by the very system.

Sustainable Process of Clean Energy Generation and Distribution, Belonging to the Field of Energy Production.

It refers, specifically, to a process that comprises a generator itself, being it, an engine, a reductor, potential transformer, current rectifier, also called electroelectronic switched power supply, and finally battery bank.

The present invention comprises an energy generator that waives re-feeding, either by means of gas, alcohol, gasoline, diesel, and coal, wind, nuclear, thermoelectric, hydroelectric or any other. Those that exist so far are fed by fuel from an own power supply, as a reservoir or a connection to an energy network, which repels the hypothesis of self-sufficiency. On the other hand, the generator above described overcomes all those difficulties related to supplying.

That happens because the generator in species presents determined characteristics, and the main of them is that which, after a star-up driven by the first battery bank, the generator starts providing its very energy to the second battery bank, in a continuous cycle. The functioning of the process may also receive a power supply of electric energy from out of the system. Such as, “electric energy” provided with hydroelectric, thermoelectric, nuclear, Eolian, solar energy or any other system that produces electric energy. However, the process always provides more energy than what receives.

As an example, it may be mentioned:

1. The process, in its generator, receives electric energy in a 2500 watts power from out of the system and provides 10.000 watts of power in electric energy.

2. The process receives electric energy in 10.000 watts power from out of the system and provides 40.000 watts of power in electric energy.

3. The process receives electric energy in 25.000 watts power from out of the system and provides from the systems 100.000 watts in power of electric energy. Such mentioned values of power in watts may have a variation in accordance with the capacity of the system components, that is, the generator, the engine and the reductor being altered, the capacity in watts received from outside and provided to the system is changed.

The system consists basically of two battery banks 1 1A that are used for the start-up of the electric engine, speed reductor and electric generator, always emphasizing that the equipment does not depend of feeding, once the energy is provided by the very system. The coupling of the generator, reductor and engine is accomplished by means of central axes.

Under the technical point of view, now taking into consideration all the attention due, the functioning takes place in two 1 LA battery banks; the first bank provides energy for the start-up of the engine, making that the generator 4 provides energy enough for the feeding of the second 1A battery bank, and so, in a continuous mode, provides electric energy to third-parties. After a given programmed time frame, the battery feeding and the system energy supply is inverted between the battery banks.

The system components for this accomplishment are: a 1.000 to 150.000 watts 4 generator; an electric engine of continuous or alternated current(AC/DC), with variable tensions; two battery banks, the tensions and electric currents ranging along the number of batteries 1, 1A of each bank; an electric or electronic component, for the control of the RPM rotation; voltmeters and ampere meters of continuous or alternated current; a display to mark the RPM, counters; circuit breakers; relays; temporizers; signaling devices and selecting switches, standing out that all those components present continuous and alternated electric currents(AC/DC).

The generator is destined to produce electric energy for the very functioning of the system and to distribute electric energy in the nominal tensions of monophase 127 and 220 volts; three phase 220, 380 and 440 volts. Two battery banks are used making the closing in each bank to 12 volts. When the number of batteries in each bank is enlarged, the electric tension or its electric current capacity is increased.

The proposed invention may act as a source of energy in residences, commercial buildings, industries, industrial machines, boats, electric cars among many others that require electric energy. The attached drawing is destined to a better comprehension of the energy generator system.

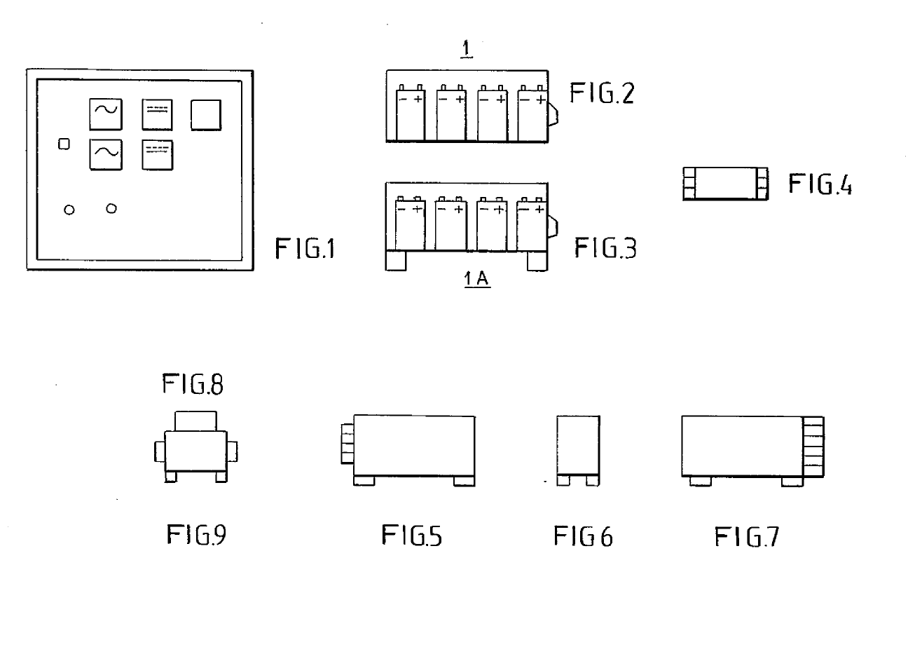

FIG. 1 is a schematic view of the command panel.

FIG. 2 is a schematic view of the primary battery bank.

FIG. 3 is a schematic view of the secondary battery bank.

FIG. 4 shows the electric-electronic switched power supply.

FIG. 5 shows schematically the electric energy generator in alternated current.

FIG. 6 is a schematic view of the speed reductor.

FIG. 7 is a schematic view of the electric engine of continuous or alternated current (AC/DC).

FIG. 8 is the rectification power supply.

FIG. 9 is the tension transformer.

### PROJECT FOR CLEAN ENERGY GENERATION

Sustainable Process of Clean Energy Generation and Distribution

1—Electric-electronic Command Panel

2—Battery Banks, which can be in tensions of 12, 24, 36, 48, 72, 96 and 125 volts. The capacity in the battery electric current—(1) can also vary.

3—Battery Bank (2) with characteristics of the (1)

4—Electric-electronic system of switched power supply with rectification and tension transformer

5—Electric Energy Generator, with variable capacities of 1,000 watts to 150,000 watts, although with a project under development for a capacity up to 500,000 watts.

6—Torque reductor and amplifier, developed to work in the 3:1 or 4:1 reduction

7—Continuous current engine, in 12, 24, 36, 48, 72, 96 and 125 tensions and electric current capacity varying in accordance with the engine watts potency. The engine contains an electric-electronic capacity system.

8—Rectification Power Supply

9—Tension Transformer

1. Sustainable process of clean energy oration and distribution, belonging to the field of energy production, characterized by a generator system that contains engine, reductor, tension transformer, current rectificator, also named electric-electronic switched power supply, and battery banks.

2. Sustainable process of clean energy generation and distribution, according to claim 1, characterized as being an energy generator that waives re-feeding, either by means of gas, alcohol, gasoline, diesel, and coal, wind, nuclear, thermoelectric, hydroelectric or any other.

3. Sustainable process of clean energy generation and distribution, according to claims 1 and 2, characterized as being a system in which the equipment does not depend on feeding, since the energy is supplied by the very system.

4. Sustainable process of clean energy generation and distribution, where the battery banks charge each other, each one charging or being charged.
